(19) United States
(12) Patent Application Publication
(10) Pub. No.: US 2004/0167809 A1
(43) Pub. Date: Aug. 26, 2004

(54) Management of multiple channels of travel services display on a dual screen monitor

(76) Inventors: Vajid Husain Jafri, Redwood Shores, CA (US); Sajid Husain Jafri, Foster City, CA (US)

Correspondence Address: ELLSWORTH R. ROSTON, ESQ., FULWIDER PATTON LEE & UTECHT, LLP, HOWARD HUGHES CENTER DRIVE, 6060 CENTER DRIVE, TENTH FLOOR, LOS ANGELES, CA, 90045, US

(21) Appl. No.: 10/672,405

(22) Filed: Sep. 26, 2003

Related U.S. Application Data
(60) Provisional application No. 60/449,292, filed on Feb. 21, 2003.

(51) Int. Cl. G06F 17/60

(52) U.S. Cl. 705/5; 705/1

(57) ABSTRACT

Individual transactions may be provided through a dedicated line from a global destination system (GDS). The transactions may related to airline flights, and costs, between an originating location and a destination. These transactions may be displayed on a first one of dual screen monitors. The individual transactions may also be provided through the internet from non-legacy airlines and on special fares from the legacy airlines. These individual transactions may be displayed on the other one of the dual screen monitors simultaneously with the display on the first one of the screen monitor. The traveler may select one of the individual transactions simultaneously displayed on the dual screen monitors.

### BACKGROUND OF A PREFERRED EMBODIMENT OF THE INVENTION

The primary airlines (e.g. American, United and Delta) have handled bookings for their flights on legacy servers which have been identified by the trademarks “Sabre®”, “Galileo®”, “Amadeus®” and “Worldspan®”. The primary airlines provide established and published flight schedules and fares for their flights in these legacy servers. The legacy servers transmit these airline flights and fares through a wide area network to processing stations (e.g. travel agencies). Travel agents at the travel agencies obtain flight and fare information for their clients at processing stations at the travel agencies. The travel agents receive commissions when they book flights through the legacy servers. However, recently the primary airlines providing flight and fare information to the legacy computers have reduced the amount of the commissions paid to travel agents when the travel agents book the flights.

A number of airlines are not in the legacy servers. They include Southwest Airlines and America West Airlines. Tickets on these airlines can be obtained by telephone calls either from the travel agent or the client. Furthermore, the airlines provide for purchases of tickets on the internet through Orbitz®. Orbitz offers tickets at reduced prices. These reduced prices are below the established and published prices which are provided in the legacy servers of the primary carriers, but these discounts are generally only for flights in the near future and are often at the least desirable hours, such as late at night. Consolidators also purchase blocks of tickets from the airlines at wholesale prices and offer these tickets through telephone lines to passengers generally at prices above the wholesale prices but below the retail price established and published by the airlines.

As will be seen from the above discussion, there are a number of different ways for a passenger to purchase airplane tickets. Some of these are at established and published retail prices. Others of these are at discounted prices. Some of these are available to travel agents and others are not. It would be desirable for travel agents to be accessible to all of these different ways of purchasing airline tickets. It would also be desirable for the travel agents to be able to offer to a client, with a minimal amount of effort, the optimal travel time for the client on a specified date at the lowest price on an airline acceptable to the client to travel from a specific originating location to a specific destination.

The following is the “Background” from the parent application:

The commercial sector of the Web has been extensively used for direct sales of travel services. At the consumer or end-user level, systems and methods for conducting e-commerce typically involve a computer running a web browser for accessing web pages from remote servers via the one and only, well-known, Internet. Computerized travel booking services, especially for air travel, have become more complex with the rise in popularity of the Internet. Not only are there many more sources of services but terms and conditions are increasingly complex. A need to manage the various complexities on a single client computer exists. Sales and ancillary sales support activity (such as ticketing) within the travel industry is typified or dominated by an airline component. Thus the airline component services of the travel industry is paradigmatically used and envisioned in accompanying diagrams. A small number of online services provide a large proportion of air travel fare quotations and ordering for air travel booked by travel agents for clients. There are four such online services; they are known by their trade names, Sabre®, Worldspan®, Galileo®, and Amadeus®. These are collectively and individually known, in the art, as GDS (global distribution system(s)).

An important reason that travel agents use GDS is that they provide familiar bookkeeping arrangements, credit, ticketing, refunds and other terms and conditions. Especially, GDS generate accounting records for computerized billing systems and reports including statistics for clients. Such report keeping is of great importance to business and corporate clients.

However, the Internet and World wide web (“the Web”) have become everyday utilities for many businesses and individuals and often provide cheaper tickets than are available through GDS's. Under price performance pressure travel agents scan the world wide web for better prices and then purchase tickets over the Internet. The travel agent must then typically enter the purchase into a GDS in order to generate the required accounting records. Often, too, a service charge (profit margin) must be charged separately, rather than a preferred method of bundling or commissions from the supplier. Another problem is that Internet sales can often have complex and unfamiliar terms and conditions with the risk that the agent may purchase a non-refundable fare only to later notice a restriction that makes the fare useless to the client. Since the terms are not presented in a standard way, they are open to misinterpretation. Also, the agent may need authorization to advance credit (usually credit card credit) for the purchase. This can result in a dilemma for the business owner as to how much authority to spend money should be given to the agent since each situation is unique. Thus, the Internet is not as travel agent friendly as the GDS. However, sometimes travel agents must use the Internet to access websites or lose business. Websites are well known in the art.

In copending non-provisional application Ser. No. 10/027,477 (attorney's file EXCAM-59170), legacy transactions, and their costs, meeting specified parameters may be provided through a wide area network to a processing station (e.g. a travel agency). These parameters may be airline flights occurring on a particular day from a specified originating location to a specified destination and specifying established and published fares of primary airlines.

Upon a request from a travel agency, individual transactions (e.g. airline flights and fares) may be provided to a database at the travel agency through the internet from legacy and non-legacy airlines. Legacy airlines may be those within a global distribution system (GDS) maintained by several of the leading airlines and the non-legacy airlines may be those not within the global distribution system. A single display screen at the travel agency displays the legacy transactions and the non-legacy transactions. The database selects one of the legacy and non-legacy transactions and provides for the printing of a ticket for the selected transaction at a printer at the travel agency and for an accounting at the travel agency.

According to a first aspect of the invention disclosed and claimed in co-pending application Ser. No. 10/027,477 (attorneys file EXCAM-59170), a method of presenting offers of travel services is disclosed. The method may include providing a client computer having a human interface, inputting requests for details of travel services, sending requests to a GDS and to a server computer, translating the request into web requests, sending web requests to websites and receiving responses therefrom, and displaying responses from the websites and from the GDS on a single display screen. According to a further aspect of the invention disclosed and claimed in copending application Ser. No. 10/027,477, software is provided to implement the method of the first aspect. According to a still further aspect of the invention, computers are provided to implement the method of the first aspect.

### BRIEF DESCRIPTION OF A PREFERRED EMBODIMENT OF THE INVENTION

Individual transactions may be provided through a dedicated line from a global destination system (GDS). The transactions may relate to airline flights, and costs, between an originating location and a destination. These transactions may be displayed on a first one of dual screen monitors.

The individual transactions may also be provided through the internet from non-legacy airlines and on special fares from the legacy airlines. These individual transactions may be displayed on the other one of the dual screen monitors simultaneously with the display on the first one of the screen monitors. The traveler or the travel agent may select one of the individual transactions simultaneously displayed on the dual screen monitors.

These and other features and advantages of the invention are set forth in part in the description which follows and in part will become apparent to those having ordinary skill in the art upon examination of the following or may be learned from practice of the invention. The advantages of the invention may be realized and attained as particularly pointed out in the appended claims. The embodiments described should be viewed as exemplary and enabling and disclosing a best known mode rather than limiting as to the bounds of the invention.

### BRIEF DESCRIPTION OF THE DRAWINGS

In the drawings:

FIG. 1 provides a high level depiction of one embodiment of the invention;

FIG. 2 provides a high level depiction of a travel agency client computer network according to an embodiment of the invention;

FIG. 3 schematically represents a client computer used in an embodiment of the invention;

FIG. 4 schematically represents a server computer such as may be used to implement embodiments of the invention;

FIG. 5 shows a client computer display screen layout such as may be used in one embodiment of the invention;

FIG. 6 shows a flow diagram of reservation functions according to an embodiment of the invention;

FIG. 7 shows a flow diagram of accounting functions according to an embodiment of the invention;

FIG. 8 is a schematic diagram showing in block form a system of the prior art for providing air flight and air fare information for global distribution systems (Sabre®, Worldspan®, Galileo®, and Amadeus®), major hotel chains and major car rental companies;

FIG. 9 is a schematic diagram showing in block form a system of the prior art for providing air flight and air fares for the airlines other than those shown in FIG. 7, for the car rental agencies other than those shown in FIG. 7, for the wholesale inventory of the airlines and for tour operators;

FIG. 10 is a schematic diagram showing in block form a system constituting a preferred embodiment of applicants' invention and providing for information relating to flight and fare information from the airlines, hotel chains, car rental companies and cruise line companies to be provided through the internet to a processing station at a travel agency;

FIG. 11 shows another preferred embodiment of the invention and shows in block form a combination of the blocks shown in FIGS. 8 and 10 to provide displays simultaneously on a display screen at the travel agency of the indications obtained from the blocks shown in FIGS. 8 and 10 and to provide a printing of a ticket for the trip indicated on the display screen and to provide for an accounting of the purchase of the ticket;

FIG. 12 shows another preferred embodiment of the invention, this combination being formed by the blocks shown in FIG. 8 and by a modification of the blocks shown in FIG. 10;

FIG. 13 is a flow chart showing the operation of the system of FIG. 11 in providing a display simultaneously on the display screen at the travel agency of the flight information provided by the blocks shown in FIG. 11;

FIG. 14 is a flow chart showing the operation of the system of FIG. 11 in providing an accounting, for the flight selected by the client or the travel agency, at the travel agency or at a legacy server also shown in FIGS. 8, 11 and 12; and

FIG. 15 is a flow chart showing the use of a dual screen monitor, one screen monitor for indicating flight information including a traveler's itinerary and flight costs, from a global display system (GDS) and the other screen monitor indicating through the internet flight information for legacy and non-legacy airlines offering flights at discounted and wholesale fares.

### DETAILED DESCRIPTION OF A PREFERRED EMBODIMENT OF THE INVENTION

The following is the “Detailed Description” from the parent application Ser. No. 10/027,477 (attorney's file EXCAM-59170):

Consumer computer systems and methods are well known in the relevant arts.

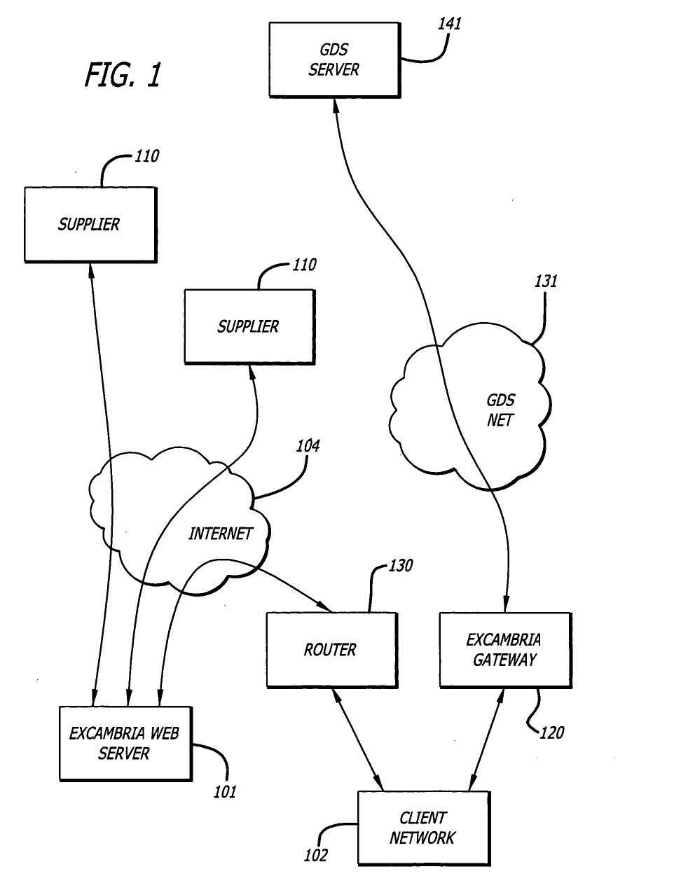

A high level depiction of one embodiment of this invention is shown in FIG. 1. Box 101 relates to one or more distributed processing servers which are well understood in the art. One particular such server that has been used to embody the invention is the Excambria™ Web Server 101 which is used as an example herein. The Figure depicts a travel agency client computer network 102 which may contain computer workstations (not shown in FIG. 1) that may connect though a router 130 and the Internet 104 to Excambria web server 101. The well known Internet Protocol (IP) is used to communicate over the Internet which is also well known in the art. Excambria™ Web Server 101 in turn connects via Internet 104 to multiple supplier server computers 110 (two shown, but typically many available). Supplier computers may typically operate as e-commerce websites, exchanging requests and responses by means of Internet oriented protocols such as FTP, HTTP, HTML, XML and/or many others. Travel agency client computer network 102 also connects through a Gateway 120 through a proprietary GDS telecommunication networks 131 to one of the several GDS's 141 that may be available and which are typically based on mainframe computers. Presently there are four GDS's 141 in total and they are well known in the art.

Again referring to FIG. 1, examples of entities that may constitute server machines (box 101) are remote servers, auction servers, transaction servers, inventory systems, supplier managed systems, etc. Parts of the invention may incorporate (have parts that are implemented on) one or more of these example entities. The invention may also incorporate entities that are not listed herein. These entities cooperate with each other in gathering, transmitting, requesting, manipulating, etc . . . travel related service information. The Internet Protocol (IP) is used for communication over the Internet (box 104) as is well understood in the art.

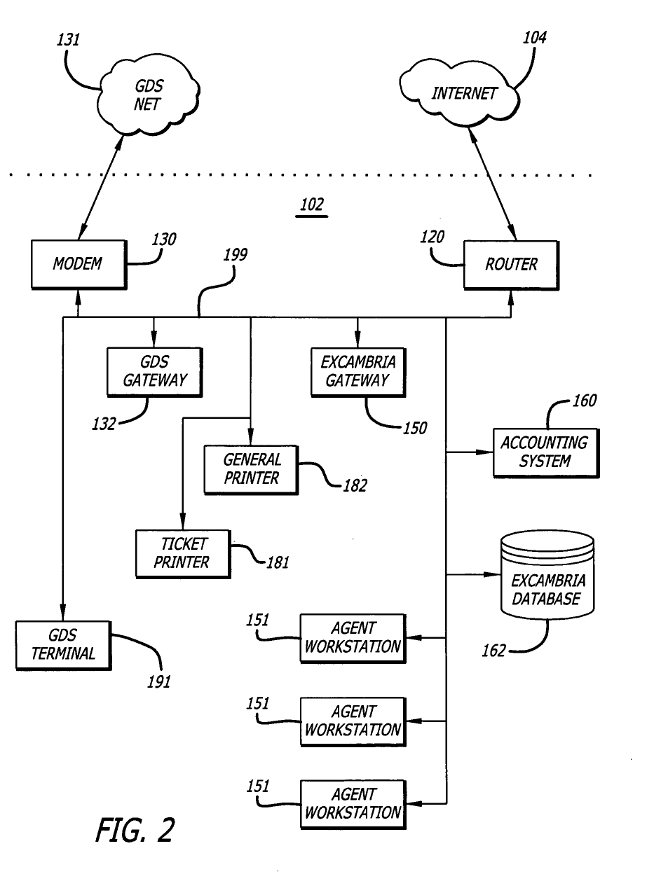

These and other features and advantages may be accomplished by the provision of alternative topologies of computer systems incorporating client computer(s), Internet server computers and GDS's. FIG. 2 shows a high level depiction of a travel agency client computer network 102 according to an embodiment of the invention. The exemplary travel agency client computer network 102 may function as depicted in FIG. 1. Still referring to FIG. 2, the travel agency client computer network 102 connects to Internet 104 and GDS proprietary network 131. Gateway 130 connects GDS network 131 and Router 120 connects Internet 104. GDS network 131 provides communication to and from a GDS (not shown in FIG. 2) and Internet 104 provides communication to and from an Excambria server (also not shown in FIG. 2). Various intelligent devices within the travel agency client computer network 102 interconnect, for example, by means of a LAN (local area network) 199 which may be Ethernet, Token Ring or other LAN technology. Optional GDS terminal 191 may be a retained or “legacy” device that may be used by travel agents to access GDS, for example, outside the context of the invention. GDS Gateway 132 operates on behalf of GDS terminal 191 to forward requests and responses to GDS network 131 via modem 130.

One or more agent workstations 151 are provided for individual use by travel agents;

typically such workstations may be implemented as software and hardware based upon the ubiquitous PC (Personal Computer). Agent workstations 151 communicate via Excambria gateway 150, LAN 199, Router 120 and Internet 104 with an Excambria web server computer (not shown in FIG. 2). Excambria gateway 150 operates on behalf of agent workstations 151 to forward requests and responses to GDS network 131 via modem 130. The accounting system computer 160 may receive messages from many sources and maintains accounting records on an accounting database (not shown). The agent workstations 151 are typically client computers (PC) that implement Excambria client programs. Agent workstations 151 may be referred to, for convenience, as communicating with a GDS, but the Excambria gateway 150 receives requests and responses and forwards them to GDS from agent workstations or vice versa.

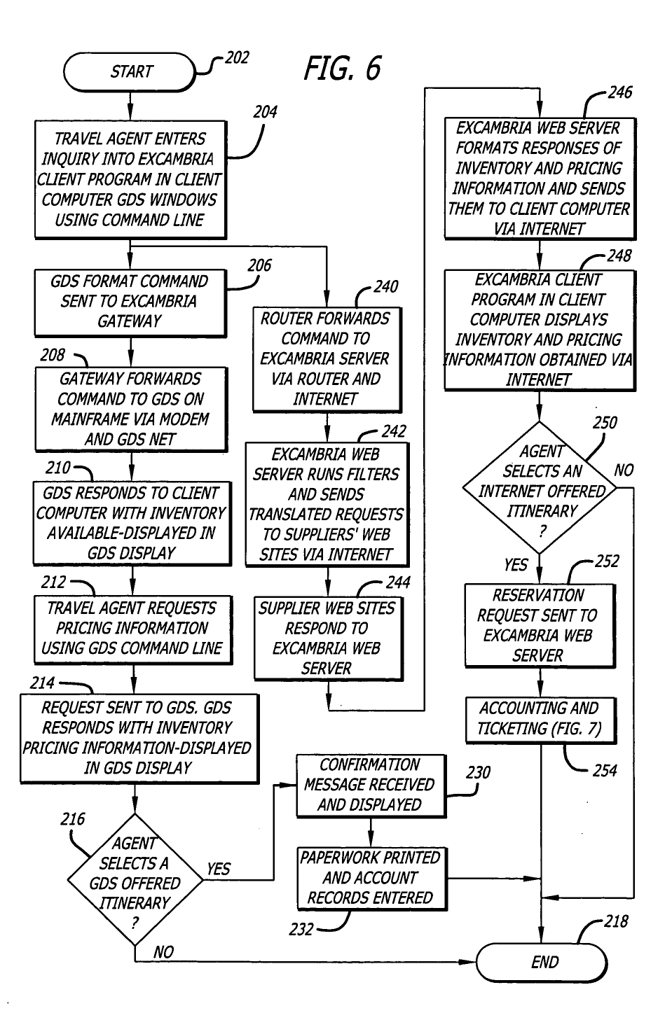

FIG. 5 shows an exemplary client computer display screen 500 layout such as may be used in one embodiment of the invention. The display screen 500 is divided into areas or windows 501, 502, 503, 504 and perhaps others. In one embodiment, the large area GDS Display window 501 provides a character-oriented scrolling window as may be required by GDS for the traditional human/compute interface thereto. Thus, a terminal emulation of a real GDS terminal optionally including features such as synchronous protocol may be performed using display window 501 and a client computer keyboard. The itinerary may be captured by filtering and interpreting a GDS formatted inquiry using command line 503 in the client computer or in an Excambria gateway or alternatively the itinerary may be entered directly using the human interface (e.g. keyboard) into command line 503. Various command “buttons” 505 for functions may be provided in accordance with the well known computer windows human interface. Window 502 may be used to display information such as inventory and pricing for itineraries located by an Excambria web server (and other web-based content) as is discussed below.

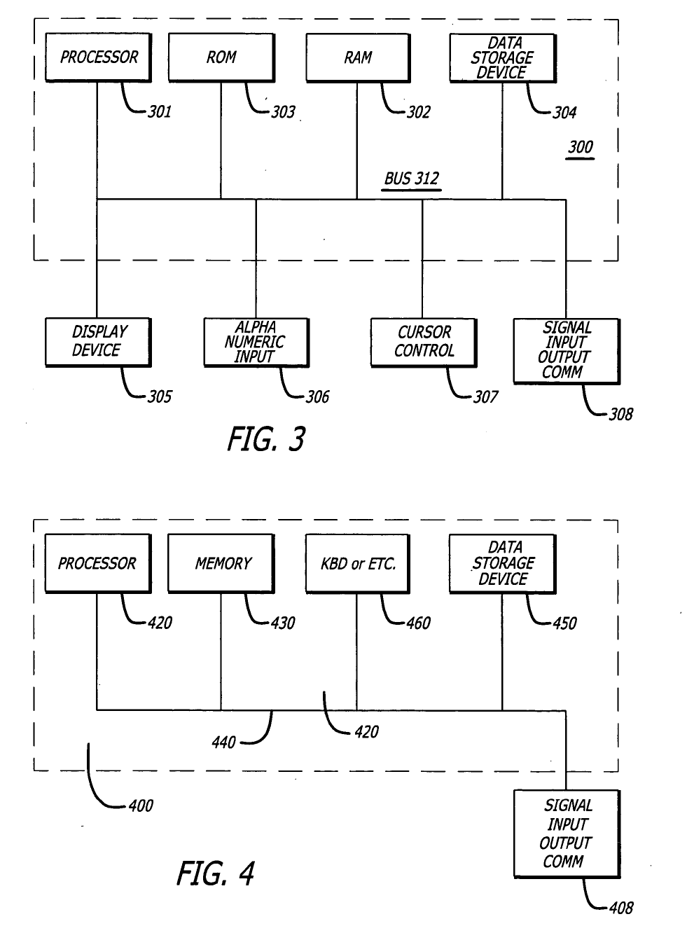

Reference is made to FIG. 3 illustrating a block diagram of a typical client computer system 300 which may be implemented or practiced by using the present invention. Such a client computer system may serve as the client computer system 102 of FIG. 1. Referring again to FIG. 3, client computer system 300 is connected to the Internet (not shown expressly, but typically via data communications port 308, sometimes known as an “I/O interface”). It is to be appreciated that client computer system 300 is exemplary only and that the present invention can operate within a number of different computer systems including general purpose computer systems, embedded computer systems, and others. In the following discussions of the present invention, certain processes and steps are realized as a series of instructs (e.g., software program) that reside within computer readable memory units of system 300 and executed by processors of system 300.

In general, client computer system 300 used by the present invention comprises address/data bus 312 for conveying information and instructions, central processor (CPU) 301 coupled with bus 312 for processing information and instructions, a random access memory (RAM) 302 for storing digital information and instructions, a read only memory (ROM) 303 for storing information and instructions of a more permanent nature. In addition, client computer system 300 may also include a data storage device 304 (e.g., a magnetic, optical, floppy, tape drive, etc.) for storing vast amounts of data, and an I/O interface 308 for interfacing with peripheral devices (e.g. computer network, modem, etc.). More particularly, the memories (e.g., RAM 302, ROM 303, and data storage device 304) of client computer 300 store the instruction codes in accordance with the present invention. A person of ordinary skill in the art will understand that the memories may also contain additional information such as applications programs, network communications programs (e.g., TCP/IP protocol), operating system software, data, etc.

Moreover, client computer system 300 may include a display device 305 for displaying information to a computer user, an alphanumeric input device 306 (e.g., keyboard), and a cursor control device 307 (e.g., mouse, track-ball, light-pen, etc.) for communicating user input information and command selections. These human oriented input and output features may be collectively used as the human interface.

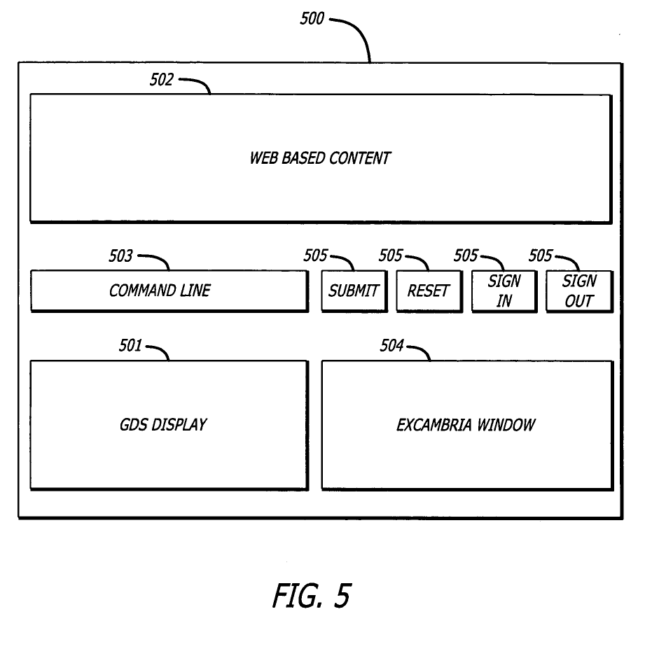

Referring to FIG. 4, server computer 400 comprises central processing CPU 420, memory 430, and communications adapter 408 which are connected together by system bus 440. Such a server computer system may serve as the Excambria server computer system 101 of FIG. 1. Memory 430 stores software. It will be understood by a person of ordinary skill in the art that server computer 400 can also include other elements not shown in FIG. 4 such as disk drives 450, keyboard 460, etc. A person of ordinary skill in the art will understand that memory 430 may also contain additional information such as applications programs, network communication programs (e.g., TCP/IP protocol stack), operating system software, data, etc. Client computer 300 and server computer 400 are linked together by a network, typically the Internet. Furthermore, a person of ordinary skill in the art will understand that the computer systems 300 and 400 may contain more or less than what is shown in FIGS. 3 and 4.

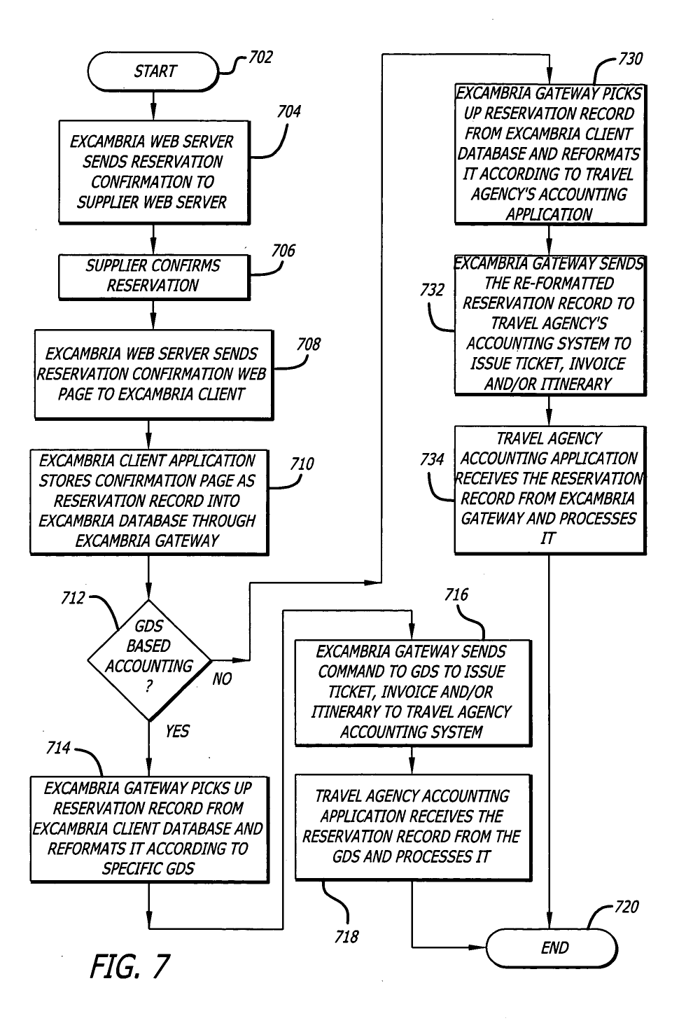

Reference is now made to FIG. 6 illustrating a flow diagram of a reservation method according to an embodiment of the invention. The Figure effectively shows the computer implemented acts to carry out part of the embodiment of the present invention. In general, the acts in FIG. 6 are designed to implement travel agent service mechanisms. The acts in FIG. 6 are carried out when processors 301 and 420 (FIGS. 3 and 4) execute the instruction codes stored in the memory of computer systems 300 and 400 (FIGS. 3 and 4). Websites and GDS, as are well known in the art, may also perform some of the necessary functions. It is to be appreciated that the acts described herein are illustrative only and other sequences of steps can be used within the general scope of the invention.

Still referring to FIG. 6, in box 202 the method is stated. In box 204, the travel agent enters an inquiry, such as for flight availability and/or pricing. The travel agent enters the inquiry into an Excambria client program in a client computer command line window using a command line format. A traditional concise GDS format may be used, for example command such as “ALAXSFO22NOV” may be used to inquire as to the availability of airline ticket for travel from Los Angeles to San Francisco on 22nd November next. The client computer software may express the inquiry as a command upon the screen. Then in box 206, the client computer software forwards the GDS format command to Excambria gateway. The gateway may be a separate computer (as shown in FIG. 2) or it can be a physical or logical subsystem of the client computer itself.

In box 208 the Gateway forwards command to GDS on mainframe via modem and the GDS Net. In box 210 the GDS responds to client computer (typically via the gateway) with inventory available which is displayed in the GDS display window. In box 212 the travel agent requests pricing information using GDS command line format. In box 214, the request is sent to GDS; GDS responds with inventory pricing information which is displayed in a GDS display window of an Excambria client program in the client computer. In box 216, the travel agent decides whether to select a GDS offered itinerary. If not, the GDS based part of the method ends in box 218. Otherwise, in box 230, the GDS itinerary is selected and a confirmation message received and displayed by old GDS based procedures. In box 232 paperwork is printed and account records entered as for old GDS systems.

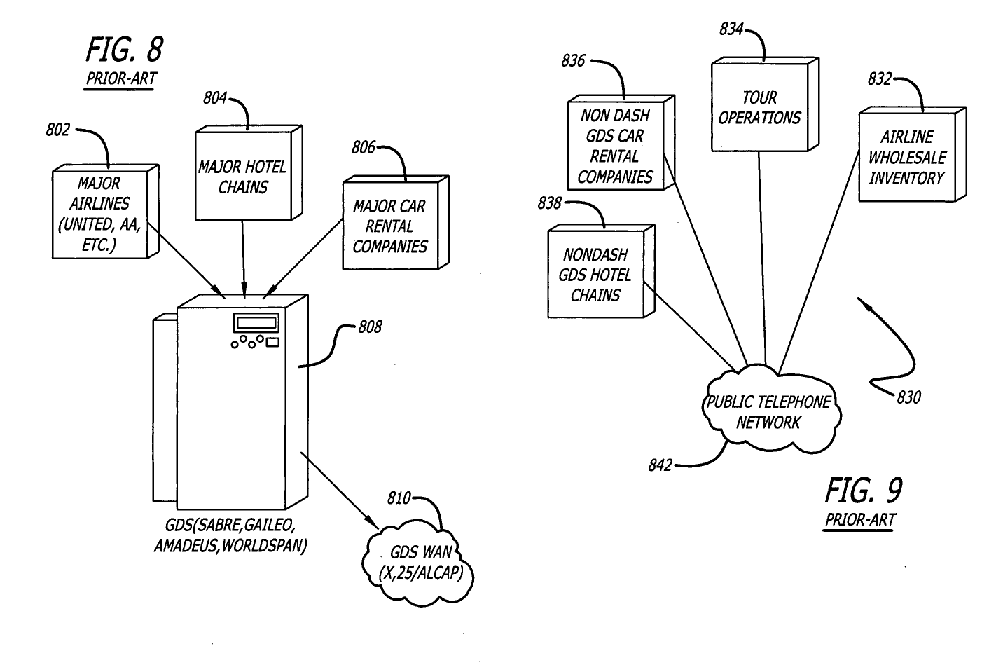

Meanwhile, in box 240, the router forwards a command to an Excambria web server via router and Internet. In Box 242, the Excambria Web server runs filters and sends translated requests to suppliers' web sites via the Internet. In box 244, the suppliers' web sites respond to the Excambria Web server. Then, in box 246, the Excambria Web server formats responses of inventory and pricing information and sends them to client computer via the Internet. In box 248, the Excambria client program in the client computer displays inventory and pricing information obtained via the Internet. Then in box 250, the travel agent decides whether to select an Internet offered itinerary. If not, then the web based part of the method ends in box 218. Otherwise, in box 252, a reservation request is sent to Excambria Web server and, in box 254, accounting and ticketing may take place as described below in connection with FIG. 7.

It should be appreciated that, as may be required, the Excambria Web server may translate commands into various forms as may be responded to by the web site of travel service suppliers such as airlines, consolidators, tour operators or the like. Thus, the Excambria server maintains a dialog with various travel sites by sending web formatted commands according to the temporal needs of the many client computers at various locations. In the example given, a request for travel information between Los Angeles and San Francisco would not generate a web site inquiry to the website of British airways since they do not offer US domestic travel. On the other hand, inquiries may be sent to the web sites of the dozen or so airlines that do offer LAX-SFO ticketing. If the agent is dissatisfied with all the itineraries offered-or if indeed there are not offers for reason of no availability-the agent may terminate the procedure and start again with, for example, a revised travel date after possible consultation with the prospective traveler.

In addition to the functions described in connection with FIG. 6, embodiments of the invention may provide for capturing accounting data for travel services booked via the Excambria Web server.

One expanded example of the functions of box 254 according to one embodiment of the invention is shown in FIG. 7. FIG. 7 shows a flow diagram of accounting functions according to an embodiment of the invention. In box 702, the method starts. In box 704, the Excambria Web server sends a reservation confirmation to a supplier web server via the Internet. In box 706, the supplier confirms the reservation. In box 708, the Excambria Web server sends a reservation confirmation web page to the Excambria client program in the client computer. In box 710 the Excambria client application program stores the confirmation page as a reservation record into an Excambria database via the Excambria Gateway. In box 712 a decision is made as to whether GDS based accounting is to be used. If so, in box 714, the Excambria Gateway picks up reservation record from Excambria client database and reformats it according to specific GDS. Then, in box 716, the Excambria Gateway sends a command to GDS to issue ticket, invoice and/or itinerary to the travel agency accounting system. In box 718, the travel agency accounting application receives the reservation record from the GDS and processes it and the method ends in box 720.

If GDS based accounting is not to be used, then in box 730 the Excambria Gateway picks up the reservation record from the Excambria client database and reformats it according to the travel agency's accounting application. In box 732, the Excambria Gateway sends the re-formatted reservation record to the travel agency's accounting system to issue ticket, invoice and/or itinerary. In box 734, the travel agency's accounting application receives the reservation record from the Excambria Gateway and processes it and the method ends.

Many other embodiments of accounting functions are feasible within the general scope of the invention. The foregoing embodiments are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those of ordinary skill in the art.

The following is the “Detailed Description of Preferred Embodiment of the Invention” which is being added in this application:

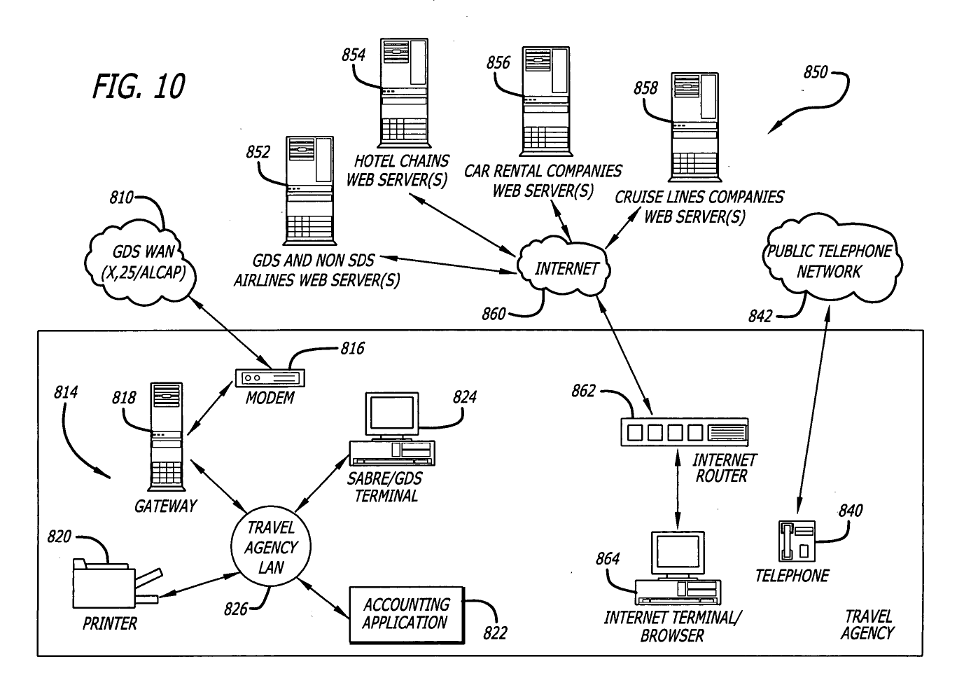

FIG. 8 is a simplified block diagram, generally indicated at 800, of a system of the prior art. The system 800 provides established and published information relating to fares from a number of major airlines 802 (e.g. American, United and Delta) relating to airplane flights and fares. It also includes room availability and room rates from a number of major hotel chains 804 and it further includes information relating to car availability and car rental rates from a number of the major car rental companies 806.

The information from the major airlines 802, the major hotel chains 804 and the major care rental companies 806 are introduced to a global distribution system (GDS) 808 which may be a legacy server. Global distribution systems now in use include Sabre, Galileo, Amadeus and Worldspan. The information from the global distribution system 808 is provided through a wide area network 810 to processing stations such as travel agencies (including a travel agency generally indicated at 812). The travel agency 812 includes a number of substantially identical processing stations, one of which is generally indicated at 814.

The processing station 814 includes a modem 816, a gateway 818, a printer 820, an accounting application 822, a global distribution system display (illustratively Sabre) display terminal 824 and a local area network (LAN) 826. The modem 816 receives information from, and provides information to, the legacy server 808 through the wide area network 810. The modem 816 provides information to, and receives information from, the gateway 818, which may be a server. The gateway 818, the printer 820, the accounting application 822 and the display terminal 824 provide information to, and receive information from, the travel agency local area network 826.

The airlines 802 introduce established and published flight and fare information to the legacy server 808 which stores this information. In like manner, the hotel chains introduce established and published information relating to room availability and room rates to the legacy server 808, and the car rental agencies 806 introduce information relating to car availability and car rates to the legacy server 808. The legacy server 808 stores this information. Whenever requested by the travel agency 812, the legacy server 808 transmits the requested information to the modem 816 in the travel agency processing station 814 through the wide area network 810.

The modem 816 at the processing station 814 introduces the requested information to the gateway 818, which may be a server. The gateway 818 then introduces this information to the local area network 826 which then introduces the information to the appropriate one of the printer 820, the accounting application 822, and the display terminal 824. The printer 820 provides a record of a flight transaction, including the flight number and the flight fare, selected by the agent at the processing station 814. The accounting application 822 provides an accounting at the processing station 814 of the flight transaction selected by the agent. The terminal 824 provides a visual indication on a display screen of information relating to the different flights requested by the agent through the wide area network 810 from the legacy server 808.

It will be appreciated that the discussion above relating to flight information and flight fares applies equally as well to information relating to room availability and room rates when the agent at the processing station 814 requests this information from the legacy server 818 through the wide area network 810. It also applies equally as well to information relating to car availability and car rates when the agent at the processing station 814 requests this information from the legacy server 808 through the wide area network 810.

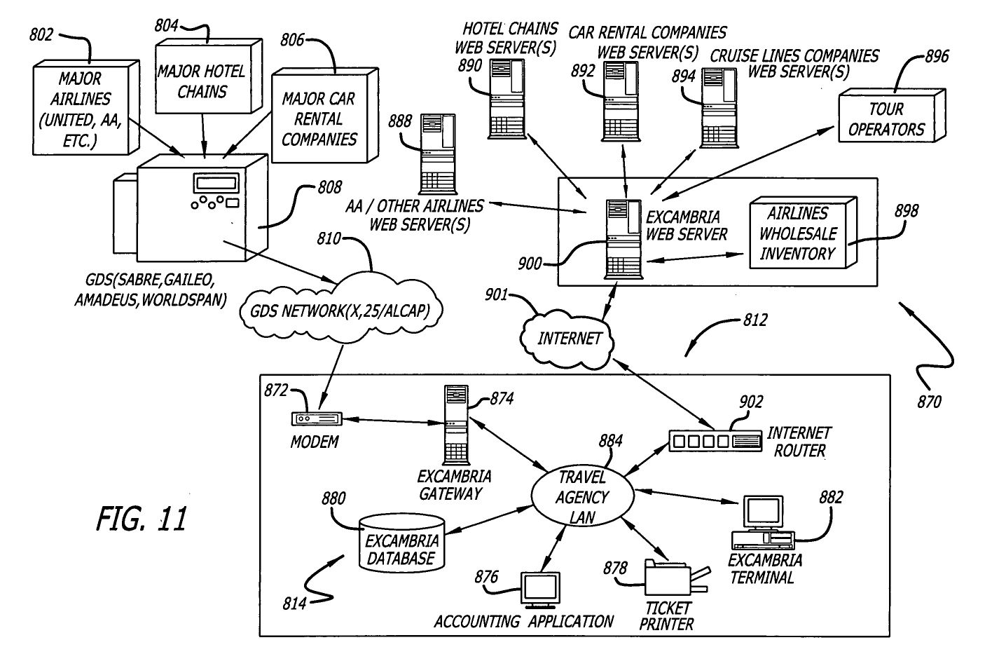

FIG. 9 shows another embodiment, generally indicated at 830, in the prior art. The embodiment 830 includes airline wholesale inventory 832, tour operators 834, non-GDS car rental companies 836 and non-GDS hotel chains 838. The airline wholesale and retail inventory is that not included in the global distribution system (GDS) 808 shown in FIG. 8. It includes airline fares discounted from the established and published fares. The non-GDS hotel chains 838 are those other than the global distribution system hotel chains included in the server 808. The tour operators 834 sponsor tours to different parts of the world and include such operators as Tauck.

The travel agency 812 obtains information from individual ones of the different inventory sources 832, 834, 836 and 838 by instituting a call from a telephone 840 at the travel station. This call passes through a public telephone network 842 to one of the sources 832, 834, 836 and 838. As will be appreciated, this mode of obtaining information is slow. It is also limited in its capabilities because the lines in the telephone network may be busy. Time is also required to connect the travel agent to the proper provider of information at the telephoned one of the sources 832, 834, 836 and 838. This is particularly true in the telephone systems at the sources where computerized machines, and not humans, answer the phone.

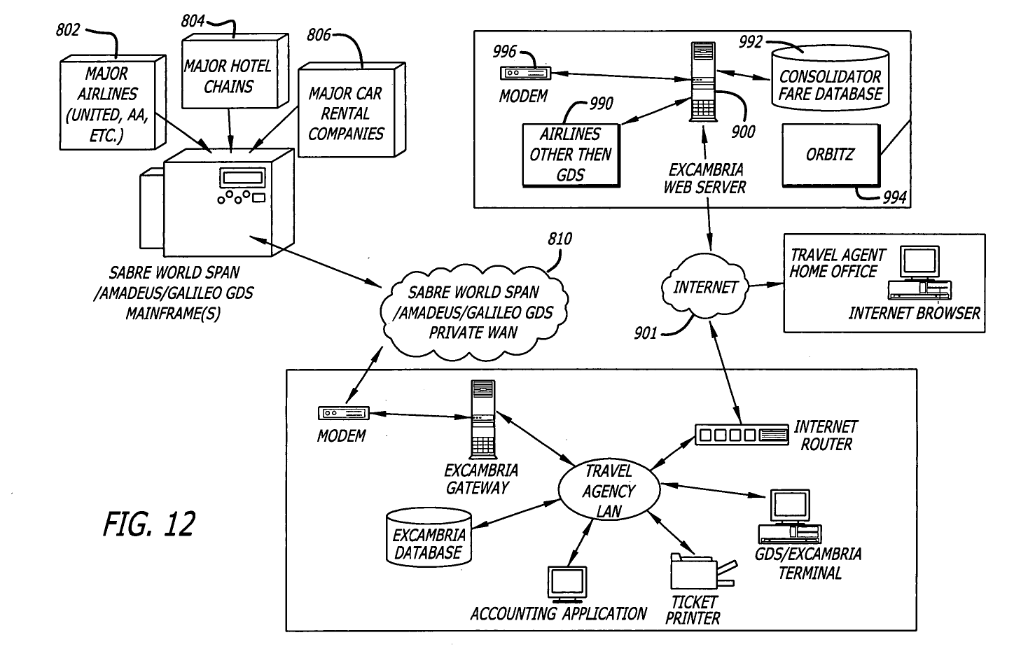

FIG. 10 shows an embodiment, generally indicated at 850, of applicants' invention.

The embodiment 850 may include web servers 852 of the global distribution system and other airlines not in the global distribution system, web servers 854 of hotel chains, web servers 856 of car rental companies and web servers 858 of cruise line companies. These companies are only illustrative, since web servers from other operational companies may also be included without departing from the scope of the invention. Information from the web servers 852, 854, 856 and 858 is passed through the internet 860 to an internet router 862 in the travel agency 860. The indications from the router 860 pass to an internet display terminal 864 which may include a browser. The system shown in FIG. 10 may also include a gateway corresponding to the gateway 818 in FIG. 8, a travel agency LAN corresponding to the travel agency LAN in FIG. 8, a printer corresponding to the printer 820 in FIG. 8 and an accounting application corresponding to the accounting application 822 in FIG. 8.

As will be seen, requests for information are provided from the travel agency 814 through the internet 860 to the sources 852, 854, 856, and 858. The requests may specify a travel date between an originating position and a destination. Responses to the requests are made through the internet by the sources 852, 854, 856, and 858. The responses may specify the travel date, the originating position, the destination, the time of departure from the originating position and the time of arrival at the destination and may further specify the travel times on the travel date for the flights and the prices for the flights. The responses cause information to be displayed on the display terminal 864. The information displayed for each response may include the airline, the travel date, the city and time of departure, the destination and the time of arrival and the price.

Communication between the travel agency 814 and the sources 852, 854, 856, and 858 through the internet offers certain advantages. One advantage is that the establishment of the communications between the web servers 852, 854, 856, and 858 and the display terminal 864 is provided in a minimal time. Another advantage is that any possibilities of busy lines as in telephone calls are minimized. A further advantage is that the cost to the operators of the web servers is minimized. Another advantage is that the flights specified by the different airlines and meeting the specifications provided by the processing station for the event can be displayed on a single display screen.

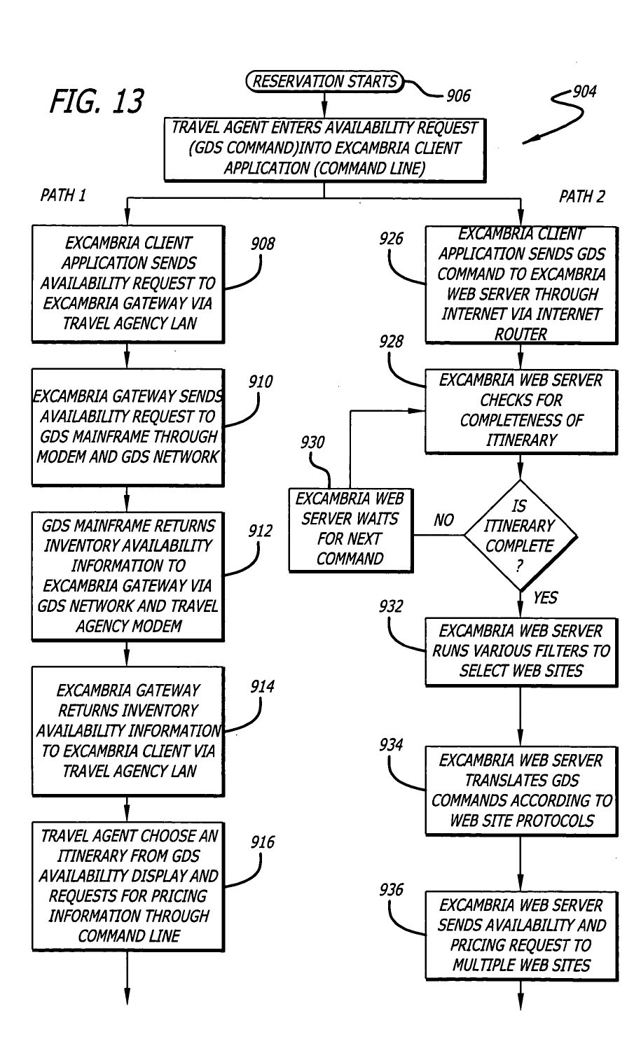

FIG. 11 shows a preferred embodiment of a system, generally indicated at 870, constituting a preferred embodiment of the invention. The system 870 includes the system 800 of the prior art as shown in FIG. 8. Thus, the stages 802, 804, 806, 808, and the wide area network 810 are the same as shown in FIG. 9. However, a modem 872, a gateway 874, an accounting application 876 and a printer 878 are different from corresponding members shown in FIG. 9 even though they have the same designations as the members shown in FIG. 9. The difference in the gateway 874 is indicated in FIG. 11 by the designation of the gateway as an Excambria gateway. An Excambria database 880 and an Excambria display terminal 882 are new in FIG. 11. Although a travel agency local area network 884 in FIG. 11 has the same designation as the network 826 in FIG. 9, it is different from the network 826 in FIG. 9. The differences between correspondingly designated stages in FIGS. 9 and 11 will be explained in detail subsequently. The travel agency local area network 884 is in two (2)-way communication with each of the Excambria gateway 874, the Excambria database 880, the accounting application 876, the ticket printer 878 and the Excambria display terminal 882.

FIG. 11 also includes an arrangement similar to that shown in FIG. 10 and discussed above. FIG. 11 includes a web server 888 for airline flight and fare information. The web server may provide flight and fare information for other airlines (e.g. Southwest Airlines) than those providing information in the legacy server 808. FIG. 11 also shows a web server 890 for other hotel chains than those providing information in the web server 804. In like manner, FIG. 11 includes a web server 892 for other car rental companies than those provided in the web server 806 for the major car rental companies.

FIG. 11 also includes web servers other than those specified in the previous paragraph. For example, a web server 894 provides information relating to cruises (e.g. cities visited, dates and other amenities) and fares offered by major cruise line companies. A web server 896 is also included in FIG. 11 for providing information relating to tour companies (e.g. Tauck Tours). A web server 898 in FIG. 11 also provides airline flight and fare information from the wholesale inventory of these airlines. It will be appreciated that the web servers capable of being used are not limited to those shown in FIG. 11. It will also be appreciated that other web servers than some of those listed in FIG. 11 can be used.

A two (2)-way communication is provided between each of the server 888, 890, 892, 894, 896 and 898 to an Excambria web server 900. The server 900 is called an Excambria server because it processes information not processed by any other server. For example, a web server corresponding to the Excambria web server 900 is not known to exist in the prior art that processes information from all of the servers 880-898 (even numbers only). The information from the Excambria server 900 is introduced to an internet router 901 in the processing station 814 at the travel agency 812. A two (2)-way communication is provided between the internet router 902 and the travel agency local area network 884.

The operation of the web servers 802-808 (even numbers only) in FIG. 11 in providing information through the wide area network 810 to the processing station 814 in the travel agency 812 and in receiving information through the internet from the web server 808 has been discussed previously in connection with FIG. 8. The operation of the web servers 888, 890, 892 and 896 in providing information to the travel agency through public telephone lines 842 has been discussed in detail previously in connection with FIG. 9. However, in FIG. 10, the information from the web servers 888, 890, 892 and 896 is provided to an Excambria web server 900. It is designated as an Excambria web server because it receives information from other sources than is provided to the public telephone lines 842 in FIG. 9 and because there in no web server in FIG. 9.

FIG. 11 shows that information is introduced to the Excambria web server 900 from the web server 888. The web server 888 provides flight and fare information from other airlines than those represented in the legacy web server 808. For example, Southwest Airlines is a good example of this. The Excambria web server 900 also receives information from the web server 894, which provides information from cruise line companies (e.g. Carnival) for various types of cruises such as ocean cruises.

The information from the legacy web server 808 passes through the wide area network 810, the modem 872 and the Excambria gateway 874 to the local area network 884 at the travel agency 812. The information from the Excambria web server 900 passes through the internet router 902 to the local area network 884 at the travel agency 812. The Excambria database 880 receives the information from the travel agency local area network 884.

The information passing to the Excambria database 880 from the legacy server 808 may have a different protocol than the information passing to the database from the Excambria web server 900. The Excambria database 880 converts the non-compatible protocol information from the web servers 808 and 900 into a compatible protocol. This information then passes through the local area network 884 to the Excambria display terminal or display screen 882. The Excambria display terminal 882 is constructed in a manner similar to that shown in FIG. 5 and described above.

The information from the legacy server 808 is displayed in the portion 501 of the display terminal 882 in FIG. 5 and the information from the Excambria web server 900 is displayed in the portion 502 of the display terminal 882 in FIG. 5. A portion 504 of the display terminal 500 in FIG. 5 may indicate the particular flight which the travel agent is investigating at any particular time. For example, the portion 504 of the display terminal 500 in FIG. 5 may indicate that the travel agent is investigating the particulars of a flight 222 on American Airlines from Los Angeles to Boston on Jan. 24, 2002.

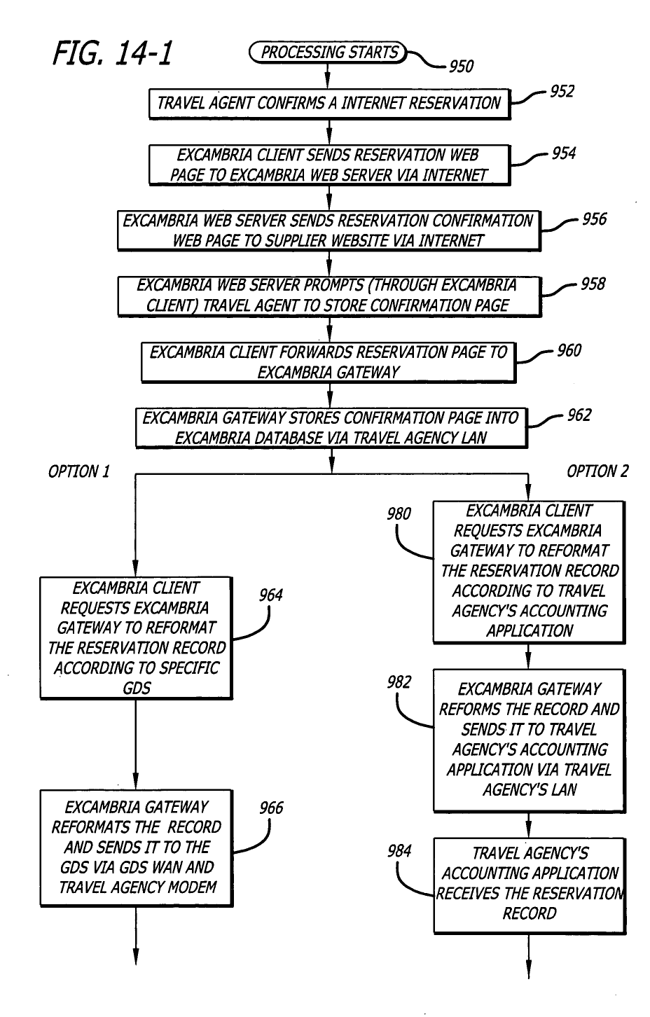

The simultaneous display on the display terminal 882 in FIG. 13 of information from the legacy server 810 and Excambria web server 900 offers certain advantages. It allows the travel agent at the travel agency 812 to see the information from all of the available sources at the same time. For example, it allows the travel agent to view the flight and fare information relating to travel on a particular date between two specified locations from the major airlines at their established and published fares and from the other airlines at their established and published fares and also to see discounted fares from the airlines and wholesale fares from the airlines, all for flights on a specified day between a specified originating location and a specified destination. This allows the travel agent and the client to make a decision based upon all available fares, all of which are made available to the agent at the same time.

When the travel agent and the client select a particular airline flight, the Excambria database 880 provides this information to local area network 884. The local area network 884 then transmits this information to the ticket printer 878 at the travel agency 814 or to the legacy server 808 to have a ticket printed. This choice may be made by the processing station 814 at the travel agency 812. When the ticket is to be printed at the local travel agency 812, the transmission of the request to have the ticket printed at the travel agency is made from the Excambria database 880 through the local area network 884 to the ticket printer 878. When the ticket is to be printed at the legacy server 808, the request to have the ticket printed is made from the Excambria database 880 through the local area network 884, the Excambria gateway 874 and the modem 872 to the legacy server 808.

In addition to the advantages discussed above, the system in FIG. 11 provides other advantages, particularly to the travel agent at the travel agency 812. As previously indicated, the airlines, particularly the major airlines listed in the legacy server 808, have been reducing the commissions paid to travel agents for generating tickets for flights on these airlines. The system in FIG. 11 provides the travel agents an opportunity to obtain discounted fares from the airlines and to charge a commission on these discounted fares when the travel agent quotes the discounted fares to the client. The travel agent can do this by quoting to the client a single price which includes the discounted fare and the commission. The client profits from this discounted fare (even with the commission added) because the client does not have to pay the established and published fare of the airlines. There is another advantage in the system of FIG. 11 to the travel agent. This results from the fact that the travel agent can obtain information from all of the available sources in a minimal amount of time and can have all of this information posted on the display terminal 882 at the same time. This facilitates the selection by the agent of the best flight arrangement for the client in a minimal period of time, this decision being based upon all of the available facts. The system is also advantageous to the airlines because it allows the airlines to the significantly reduce their cost, particularly their selling and marketing expenses.

The system is further advantageous to the efficient airlines because their fares will be below those of the inefficient airlines and this will be readily apparent on the split screen 500 in FIG. 5.

FIG. 13 is a flow chart, generally indicated at 904, showing the successive steps involved in operating the system shown in FIG. 11 and described above. As a first step (906), the system is activated. The travel agent at the travel agency 812 then sends (908) an availability request through the local area network 884 and the Excambria gateway 874 to the legacy web server 808 (910). The global distribution system then returns (912) the inventory availability information to the Excambria gateway 874 through the wide area network 810 and the modem 872. In other words, the Excambria web server 808 indicates to the Excambria gateway 874 whether seats are available on a specified flight and, if so, what the prices of the seats are. The Excambria gateway 874 indicates this seat availability, and the prices of the available seats, through the local area network 884 to the Excambria terminal 882. This is indicated at 914 in FIG. 13.

At 916, the travel agent selects an itinerary from the global distribution system available in the legacy server 808 and requests pricing information relating to the itinerary. The travel agency 812 sends, as indicated at 918 and 920, a pricing request for the selected flight to the legacy server 808 through the travel agency local area network 884, the Excambria gateway 874, the modem 872 and the wide area network 810. The legacy server 808 then sends the requested information to the display terminal 882 at the processing station 814 in the travel agency 812 through the wide area network 810, the modem 872 and the local area network 884, as indicated at 922 and 924 in FIG. 13.

The travel agent at the travel agency 812 may also send requests for information through the local area network 884, the router 902 and the internet 901 to the Excambria web server 900. This is indicated at 926 in FIG. 13. The Excambria web server 900 checks (928) for the completeness of the itinerary transmitted to it from the local area network 884. If the itinerary is not complete, the Excambria web server 900 waits for the next command from the local area network 926. See 930 in FIG. 13. If the itinerary is complete, the Excambria web server 900 activates (932) various filters to select web sites in the Excambria server. This is indicated at 932 in FIG. 13. The Excambria web server 900 then translates (934) the global distribution system commands from the web server 908 according to the protocols in the selected web sites.

The Excambria web server 900 then sends (936) the flight availability and pricing requests to multiple websites in the Excambria server and receives (938) the flight availability and pricing information from the multiple web sites. The Excambria web server 900 aggregates (940) the flight availability and pricing information from the multiple web sites. As indicated at 942, the Excambria web server 900 thereafter submits the flight availability and pricing information to the Excambria database 880 at the processing station 814 in the travel agency 812. The travel agent then selects a flight itinerary, and a pricing information for that itinerary, from the global distribution system information in the legacy server 808 and the individual flight in the Excambria web server 900. The reservation of the selected flight itinerary and fare is now complete. See 946 in FIG. 13.

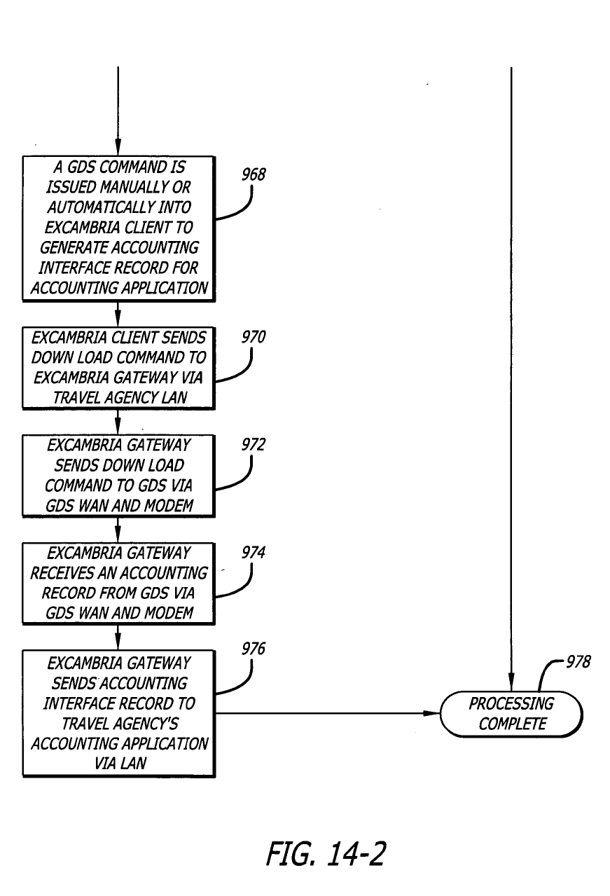

FIG. 14 is a flow chart indicating the steps in providing an accounting after the flight itinerary and price have been selected on the basis of the information in the Excambria database 880 in FIG. 11. The processing of the accounting commences at 950 in FIG. 14. The travel agent confirms a ticket reservation, as at 952, on the internet 901 or in the global distribution system network 810. See 954 in FIG. 14. The travel agency 812 then sends (954) the reservation web page to the Excambria web server 900 via the internet 901. The Excambria web server 900 thereafter sends (956) the reservation confirmation web page to the web site at the travel agency 812 through the internet 901 and prompts (958) the travel agency to store the confirmation page. The travel agency 812 subsequently forwards the reservation page to the Excambria gateway 874 at the travel agency 814. See 960 in FIG. 14. The Excambria gateway 874 thereafter stores the flight confirmation page in the Excambria database 880 at the travel agency 812 in FIG. 11 as indicated at 962 in FIG. 14.

Thee are then two (2) options. One option is indicated in the sequence of blocks at the left end below the block 962. The other option is indicated in the sequence of blocks at the right and below the block 962. In option one (1) at the left end below the block 962, the travel agent requests through the Excambria database 880 the legacy server 808 in FIG. 11 to reformat the reservation on record in accordance with the global reservation system protocol. This is indicated at 964 in FIG. 14. The Excambria gateway 874 reformats the reservation record and sends it to the legacy server 808 via the modem 872 and the wide area network 810. See 966 in FIG. 14. A global distribution system command is then issued (968) manually or automatically at the travel agency 812 to generate an accounting interface record for the accounting 876 in FIG. 11.

The processing station at the travel agency 812 thereafter sends a load command to the legacy server 808 through the modem 872 and the wide area network. This is indicated at 972. After that, the Excambria gateway 874 receives an accounting record from the legacy server 804 through the wide area network 810 and the modem 872. See 974 in FIG. 14. The Excambria gateway then sends the accounting interface record to the accounting application 876 through the local area network 884 in FIG. 11. The accounting application makes a recording of such information as the client, the ticket sold to the client, and the price of the ticket. The process is now complete. See 978 in FIG. 14.

In option two (2), after the storage of the confirmation page in the Excambria database 880 (see 962), the travel agency 814 requests (980) the Excambria gateway 874 to reformat the reservation record according to the accounting application 876. (See 982 in FIG. 14.) The Excambria gateway 874 then provides this reformatting and sends it to the accounting application 876 through the local area network 884. See 982 in FIG. 14. The accounting application 876 receives and records the reservation information as at 984. The processing of the accounting record in now complete (978).

The ticketing of the selected flight by the travel agent for the client may have a flow chart substantially identical to the flow chart shown in FIG. 14. However, instead of specifying the accounting application as in FIG. 14, the flow for the ticket printer would substitute the word “printer” for the words “accounting applications”. In this way, the ticket can be printed either at the legacy server 808 (option 1) or the ticket can be printed at the ticker printer 878 (option 2).

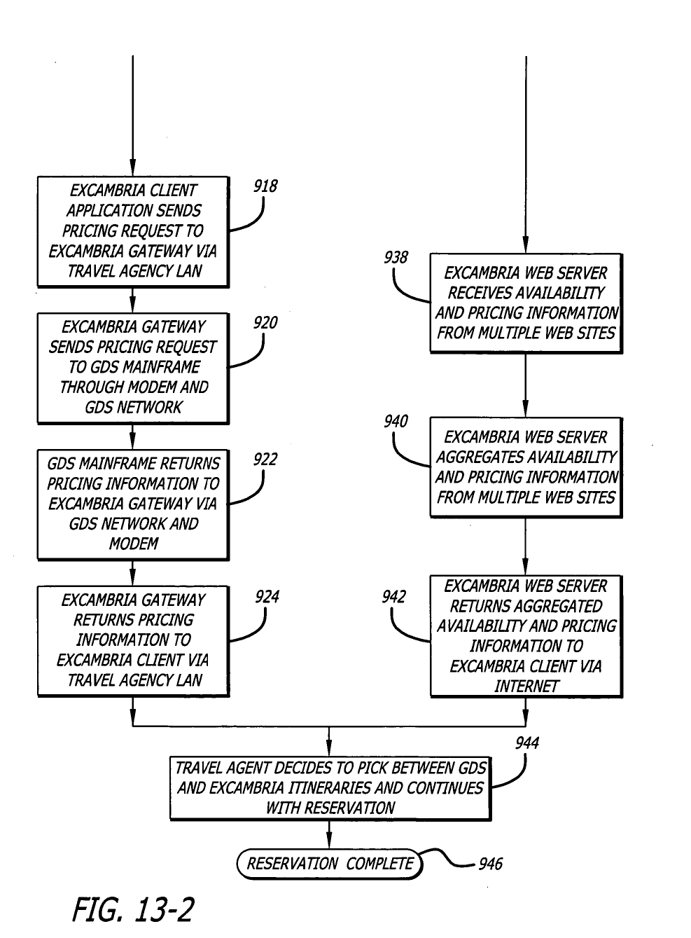

FIG. 12 is similar to FIG. 11. However, in place of the six (6) web servers feeding information into the Excambria web server 900 as shown in FIG. 11, three (3) other web servers feed information into, and receive information from, the Excambria web server 900. These are (a) a web server 990 providing information relating to airlines (e.g. Southwest Airlines) other than the primary airlines (e.g. American, United and Delta) in the legacy web server 808, (b) a web server 992 providing a database for consolidators (companies which purchase blocks of tickets from the airlines at discounted prices and offer these tickets to the public at prices above the discounted prices but below the established and published prices) and (c) a web server 994 for Orbitz. Information in the Orbitz web servers 994 relates to last minute reductions in price by the airlines for flights which will be somewhat empty if the prices of the flights are not steeply discounted. The information from the web servers 990, 992 and 994 are introduced through the internet 901 to the travel agency 812 and information from the travel agency is introduced through the internet to the web servers 990, 992 and 994.

It will be appreciated that the web servers 990, 992 and 994 are shown in FIG. 12 separately from the web servers 888-898 (even members only) in FIG. 11 only for purposes of convenience. The web servers associated with the Excambria web server 900 in FIGS. 11 and 13 may constitute any one of any combination of the web servers shown in FIGS. 11 and 13. Furthermore, the use of the system shown in FIGS. 11 and 12 is not limited to the web servers shown in FIGS. 11 and 13. This will be obvious to a person of ordinary skill in the art.

A modem 996 is shown in FIG. 12 for providing a two (2)-way communication between the Excambria web server 900 and the legacy server 808. This two (2)-way communication is provided through the wide area network 810 between the modem 996 and the legacy server 808.

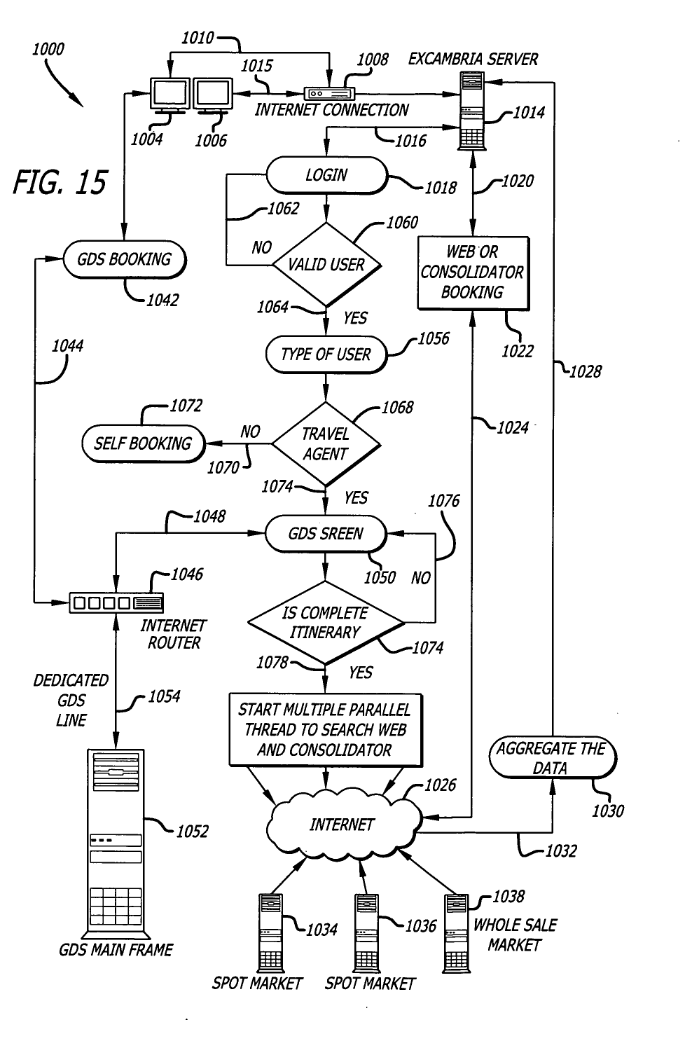

FIG. 15 is a flow chart generally indicated at 1000, showing the inventive features included in this application. The flow chart 1000 includes a dual screen monitor generally indicated at 1002 and constituting monitors 1004 and 1006. The flow chart 1000 also includes an internet connection 1008 which may be a router. A line or bus 1010 extends between the internet connection 1008 and the left screen monitor 1004 to provide two-way communication between the internet connection and the screen monitor. A line or bus 1012 also extends between the internet connection 1008 and an Excambria server 1014 to provide a two-way communication between the internet connection and the server. A line or bus 1015 provides a two-way connection between the internet connection 1008 and the right screen monitor 1006.

A two-way connection is provided by a line or bus 1016 between the Excambria server 1014 and a log-in server 1018. A two-way line or bus 1020 is provided between the Excambria server and a Web or Consolidator Booking 1022 which may be a router. A two-way connection is provided by a line or bus 1024 extending between the Web or Consolidator booking 1022 and he internet 1026. The Excambria server 1014 also receives information through a line or bus 1028 connected between the Excambria server and a data aggregator 1030. The aggregator 1030 receives information from the internet 1026 through a line or bus 1032. The internet 1026 also receives information from spot market servers 1034 and 1036 and from a wholesale market server 1038. The servers 1034, 1036 and 1038 may also provide web booking information and consolidator booking information shown in the web or consolidation booking 1022.

A two-way connection is provided by a line or bus 1040 between the left screen monitor 1004 and a global distribution system (GDS) booking 1042 which may be a router or a router/gateway. A line or bus 1044 provides a two-way connection between the GDS booking 1042 and a router 1046. The router 1046 has a two-way connection through a line or bus 1048 with a GDS screen 1050 which may constitute the left screen monitor 1004. The router 1046 also has a two-way connection with a GDS mainframe 1052 through a line or bus 1054.

The Excambria server 1014 activates the login 1018 through the bus 1016. A determination is then made as at 1060 whether or not the user is a valid user. If the answer is no (see 1062), an indication to this effect is provided to the login to initiate another inquiry. If the answer is yes (see 1064), an inquiry is made as at 1066 as to the user's type. This inquiry relates to whether the user is a travel agent. This is indicated at 1068. If the answer is no (see 1070), the user provides a self booking. This is indicated at 1072. In a self booking, the user operates the screen monitor 1006 but does not have the advantage of using the internet 1026 or the Excambria server 1014.

If the user is a travel agent, this is indicated at 1074. An itinerary of the user's planned airplane trip is then indicated on the GDS screen monitor 1050 which is the left one 1004 of the dual screen monitor 1002. The GDS screen monitor will accordingly indicate such information as the number of persons traveling, the date of the travel and the departure and arrival locations. A determination is then made as at 1024 as to whether the itinerary listed on the screen monitor 1050 is complete. If the itinerary is not complete, an indication is provided at 1076 and the user is returned to the GDS screen monitor 1050 to have the itinerary completed by the user.

If the user's itinerary is complete, an indication is provided as at 1078. A search is then instituted in the internet 1026 of suitable flights meeting the user's itinerary criteria. The search may include the servers 1034 and 1036 for the spot market and the server 1038 for the wholesale market. These servers may also include information relating to the web booking and the consolidator booking also shown at 1022. The information may include the identity of airlines, flight numbers, departure times and departure locations, arrival times and locations and prices. The data for the different flights is aggregated as at 1030 and is introduced to the Excambria server 1014. The information passes from the Excambria server 1014 to the internet connection 1008 and from there to the right one 1006 of the dual screen monitors. The information for different flights is provided at the right one 1016 of the dual screen monitors 1002 so that the user and the travel agent can make a selection from among a number of different flights.

As previously indicated, the traveler's itinerary is entered by a travel agent in the GDS screen monitor 1050, which is the same as the left screen monitor 1004 in the dual screen monitor 1002. The itinerary recorded in the monitor 1004 passes through the GDS booking 1042 (which is a router or a router/gateway) to the router 1046. From there, the itinerary passes through the dedicated GDS line 1054 to the GDS main frame 1052. The GDS main frame 1052 holds information relating to the flights of major airlines in the United States. As previously indicated, the GDS main frame indicates the air travel flight and published fare quotations from four (4) online services approved by major airlines in the united States and booked by travel agents for their clients. These four (4) major online services are known by their trade marks Sabra®, Worldspan®, Galileo® and Amadeus®. They are collectively and individually known in the art as GDS (Global Distribution System(s)).

The travel agent then selects from the GDS main frame 1052 information relating to the flights from the different airlines that fit most closely the parameters listed in the traveler's flight itinerary. This information passes through the dedicated GDS line or bus 1054, the router 1046 and the GDS mainframe booking 1042 to the left one 1004 of the dual screen monitor 1002. The information from the GDS mainframe 1052 is displayed on the screen monitor 1004.

In this way, the information from the GDS mainframe 1052 relating to scheduled fares for scheduled flights is provided through lines or buses to the screen monitor 1004 in the dual screen monitor 1002 for display on the screen monitor. At the same time, information from other sources (e.g. spot markets, wholesale markets, web booking and consolidator booking) is provided to the screen monitor 1006 in the dual screen monitor 1002 through the internet 1026. In this way, the travel agent is able to provide simultaneously to the traveler information relating to all of the different flights available to the traveler and all of the different prices available for such flights to the traveler. The information is particularly advantageous in minimizing the costs of travel and in balancing the advantages of low cost travel against any disadvantages of flight times and flight routes between the departure or originating destination and the arrival destination. The information is advantageous to the travel agent because the travel agent can add a fee to the price quoted to the traveler when the travel agent is quoting a discount price to the traveler.

Although this invention has been disclosed and illustrated with reference to particular embodiments, the principles involved are susceptible for use in numerous other embodiments which will be apparent to persons of ordinary skill in the art. The invention is, therefore, to be limited only as indicated by the scope of the claims.

What is claimed is:

1. In a method of offering travel services for travel from a specified departure location to a specified destination at a specified time,
providing first travel information on a non-internet basis for flights between the specified departure location and the specified destination at the specified time,
providing second travel information on an internet basis for travel between the specified departure location and the specified destination at the specified time, and
providing for a visual display of the first travel information and the second travel information respectively on first and second adjacent monitors.

2. In a method as set forth in claim 1 wherein
the first travel information and the second travel information are displayed on the adjacent monitors to simplify the selection of a preferred travel by a user and to provide for the selection by the user among a full range of travel information.

3. In a method as set forth in claim 1 wherein
the first and second monitors indicate selective ones of the departure location, the destination, the time of departure and the price.

4. In a method of presenting offers of a travel service, the steps of:
sending a first request for details of the travel service to a global distribution system through a medium other than the internet,
sending a second request through the internet to a server,
receiving from the global distribution system, in response to the first request, first details of travel services,
receiving through the internet, in response to the second request, second details of travel services, and
respectively displaying the first and second details of the travel services in first and second adjacent monitors to obtain a selection of an individual one of the travel services by a user.

5. In a method as set forth in claim 4 wherein
the first and second travel services are respectively displayed in an adjacent visual relationship on the first and second adjacent monitors to facilitate the selection of the one of the travel services by the user and to provide for the selection among a full range of travel services.

6. In a method as set forth in claim 4 wherein
the first request is sent through a wide area network and the first details of the travel services are received through the wide area network and wherein
the second request is sent through the internet and the second details are received through the internet.

7. In a method as set forth in claim 4 wherein
the first and second details include selective ones of a departure location, a destination, a time of departure and a price.

8. In a method as set forth in claim 5 wherein
the first request is sent through a wide area network and the first details of the travel services are received through the wide area network and wherein
the second request is sent through the internet and the second details are received through the internet and wherein
the first and second details include selective ones of the departure location, the destination, the time of departure and the price.

9. In a method of presenting offers of a travel service, the steps of:
receiving from a first storage of information, by a medium other than the internet, first details of the travel service in response to a first request,
receiving from a second storage of information, through the internet, second details of the travel service in response to a second request, and
respectively displaying the first and second details of the travel service in a relationship on adjacent monitors to provide for a simplified selection by a user of one of the first and second details of travel service and to provide for the selection among a full range of details of the travel service.

10. In a method as set forth in claim 9 wherein
the first storage of information is in a global distribution system and the first details of the travel service are received from the global distribution system through a wide area network.

11. In a method as set forth in claim 9 wherein
the first and second details of the travel service are respectively displayed in an adjacent relationship on the adjacent monitors to provide for a simplified selection by a user of one of the first and second details of travel service and to provide for the selection among a full range of details of the travel service.

12. In a method as set forth in claim 10 wherein
the first and second details of the travel service are respectively displayed in an adjacent relationship or an adjacent pair of monitors to provide for a simplified selection by a user of one of the first and second details of travel service and to provide for the selection among a full range of details of the travel service.

13. In a method as set forth in claim 9 wherein
the first detail of the travel service are provided in a wide area network.

14. In a method of offering travel services, the steps of:
providing first travel information from a legacy server between a specified travel location and a destination for a particular date,
determining whether the itinerary information is complete,
providing second travel information from sources other than the legacy server,
providing the second travel information through the internet, and
respectively providing the first and second travel information on first and second adjacent monitors.

15. In a method as set forth in claim 14,
when the itinerary information is not complete, providing for the user to complete the itinerary information.

16. In a method as set forth in claim 14,
providing for a printing of a ticket when the ticket has been selected on the basis of an individual one of the first and second travel information.

17. In a method as set forth in claim 14,
providing accounting records of a purchases of a ticket when the ticket has been selected on the basis of an individual one of the first and second travel information.

18. In a method as set forth in claim 15,
providing for the printing of a ticket when the ticket has been selected on the basis of an individual one of the first and second travel information,
providing accounting records of a purchase of a ticket when the ticket has been selected on the basis of an individual one of the first and second travel information.

19. In a method of offering travel services, the steps of:
requesting first travel information from a legacy server,
providing the first travel information on a non-internet basis,
requesting second travel information from a source other than the legacy server,
providing the second travel information on an internet basis,
respectively displaying the first and second travel information on first and second adjacent monitors, and
printing a ticket selected from the first and second travel information.

20. In a method of providing travel information, involving particular parameters, the steps of:
providing on a non-internet basis first travel information involving the particular parameters,
providing on an internet basis second travel information involving the particular parameters, and
providing for a visual display of the first and second travel information respectively on first and second adjacent monitors.

21. In a method as set forth in claim 21 wherein
the first travel information involves legacy transactions and the second travel information involves non-legacy transactions.

22. In a method as set forth in claim 21 wherein
the first travel information is provided through a wide area network and wherein
the first travel information and the second travel information are provided in the first and second monitors at a processing station.
